(19) United States
(12) Patent Application Publication
(10) Pub. No.: US 2024/0296064 A1
(43) Pub. Date: Sep. 5, 2024

(54) JOB CONTROL SYSTEM AND CONTROL METHOD THEREOF

(71) Applicant: RAKUTEN MOBILE, INC., Tokyo (JP)

(72) Inventor: Kazushige TAKEUCHI, Tokyo (JP)

(21) Appl. No.: 18/044,083

(22) PCT Filed: Sep. 1, 2021
(86) PCT No.: PCT/JP2021/032198

§ 371 Date: Mar. 6, 2023

(51) Int. Cl. G06F 9/48

(52) U.S. Cl. CPC G06F 9/4843

(57) ABSTRACT

A name resolution module identifies an address unique to a job execution system based on a common service name that is independent of the job execution system. A job relay module acquires job data which is stored in a job data storage unit, and satisfies a condition associated with the job relay module. The job relay module outputs a job execution request in accordance with the acquired job data to the address identified by name resolution based on the common service name by the name resolution module. A job execution module receives the job execution request output to the address unique to the job execution system, and executes the job.

### TECHNICAL FIELD

The present invention relates to a job control system and a control method thereof.

### BACKGROUND ART

As an example of a technology relating to construction of a functional unit group in accordance with purchase of a network service, in Patent Literature 1, there is described a technology for deconstructing an order of a product purchased by a customer into virtualized network function (VNF) units and deploying the VNF units on a network functions virtualization infrastructure (NFVI).

### CITATION LIST

### Patent Literature

[Patent Literature 1] WO 2018/181826 A1

### SUMMARY OF INVENTION

### Technical Problem

In the technology as described in Patent Literature 1, efficient execution of jobs such as VNF deployment is possible by executing the jobs in a distributed manner across a plurality of job execution systems. In this way, even when an event such as system failure occurs in a certain job execution system, the job to be executed by that job execution system may be executed by another job execution system instead, and therefore availability of the job execution system is improved.

However, in the technology as described in Patent Literature 1, in order to execute a job to be executed in a job execution system in which an event such as a system failure has occurred in another job execution system instead, various settings changes are required, and this takes time and effort.

The present invention has been made in view of the above-mentioned circumstances, and has an object to provide a job control system and a control method thereof which are capable of smoothly executing a job to be executed in a certain job execution system in another job execution system instead.

### Solution to Problem

In order to solve the above-mentioned problem, according to one embodiment of the present invention, there is provided a job control system including: job data storage means for storing job data indicating a job to be executed; and a plurality of job execution systems each configured to execute at least a part of the job data stored in the job data storage means, each of the plurality of job execution systems including: at least one job relay means each associated with a condition; name resolution means for identifying an address unique to the each of the plurality of job execution systems based on a common service name that is independent of the each of the plurality of job execution systems; and job execution means for receiving a job execution request output to the unique address and executing the job, wherein the job relay means is configured to acquire the job data which is stored in the job data storage means, and satisfies the condition associated with the job relay means, and wherein the job relay means is configured to output a job execution request in accordance with the acquired job data to the address identified by name resolution based on the common service name by the name resolution means of one of the plurality of job execution systems in which the job relay means is included.

In one aspect of the present invention, the job control system further includes execution control means for executing control so that, in response to occurrence of a predetermined event in any one of the plurality of job execution systems, the job relay means executed in the one of the plurality of job execution systems is executed in another job execution system.

Otherwise, the job control system further includes: stop means for stopping, in response to occurrence of a predetermined event in any one of the plurality of job execution systems, the at least one job relay means executed in the one of the plurality of job execution systems; and execution control means for executing control so that the at least one job relay means is executed in another job execution system.

Further, in one aspect of the present invention, the job data is linked to location data indicating a location, the job relay means is associated with the location, and the job relay means is configured to acquire the job data which is stored in the job data storage means, and is linked to the location data indicating the location associated with the job relay means.

Further, according to one embodiment of the present invention, there is provided a control method for a job control system, the job control system including: job data storage means for storing job data indicating a job to be executed; and a plurality of job execution systems each configured to execute at least a part of the job data stored in the job data storage means, each of the plurality of job execution systems including: at least one job relay means each associated with a condition; name resolution means for identifying an address unique to the each of the plurality of job execution systems based on a common service name that is independent of the each of the plurality of job execution systems; and job execution means for receiving a job execution request output to the unique address and executing the job, the control method including the steps of: acquiring, by the job relay means, the job data which is stored in the job data storage means, and satisfies the condition associated with the job relay means; and outputting, by the job relay means, a job execution request in accordance with the acquired job data to the address identified by name resolution based on the common service name by the name resolution means of one of the plurality of job execution systems in which the at least one job relay means is included.

### BRIEF DESCRIPTION OF DRAWINGS

FIG. 1 is a diagram for illustrating an example of a job control system.

FIG. 2 is a diagram for illustrating an example of a configuration of a job execution system.

FIG. 3 is a diagram for illustrating an example of a DNS record.

FIG. 4 is a diagram for illustrating an example of the DNS record.

FIG. 5 is a diagram for illustrating an example of the DNS record.

FIG. 6 is a diagram for illustrating an example of a functional configuration of a monitoring management module.

FIG. 7 is a diagram for illustrating an example of the job control system.

FIG. 8 is a diagram for illustrating an example of the job control system.

FIG. 9 is a diagram for illustrating an example of a functional configuration of the monitoring management module.

FIG. 10 is a diagram for illustrating an example of the job control system.

FIG. 11 is a diagram for illustrating an example of a functional configuration of a job execution module.

FIG. 12 is a diagram for illustrating an example of a functional configuration of the job execution module.

FIG. 13 is a diagram for illustrating an example of the job control system.

FIG. 14 is a diagram for illustrating an example of a functional configuration of the monitoring management module.

FIG. 15 is a diagram for illustrating an example of the job control system.

FIG. 16 is a diagram for illustrating an example of the job control system.

FIG. 17 is a diagram for illustrating an example of a functional configuration of the monitoring management module.

FIG. 18 is a diagram for illustrating an example of the job control system.

FIG. 19 is a diagram for illustrating an example of a functional configuration of the job execution module.

FIG. 20 is a diagram for illustrating an example of a functional configuration of the job execution module.

FIG. 21 is a flow chart for illustrating an example of a flow of a process executed by a job relay module.

FIG. 22 is a flow chart for illustrating an example of a flow of a process executed by the monitoring management module.

### DESCRIPTION OF EMBODIMENTS

One embodiment of the present invention is now described in detail with reference to the drawings.

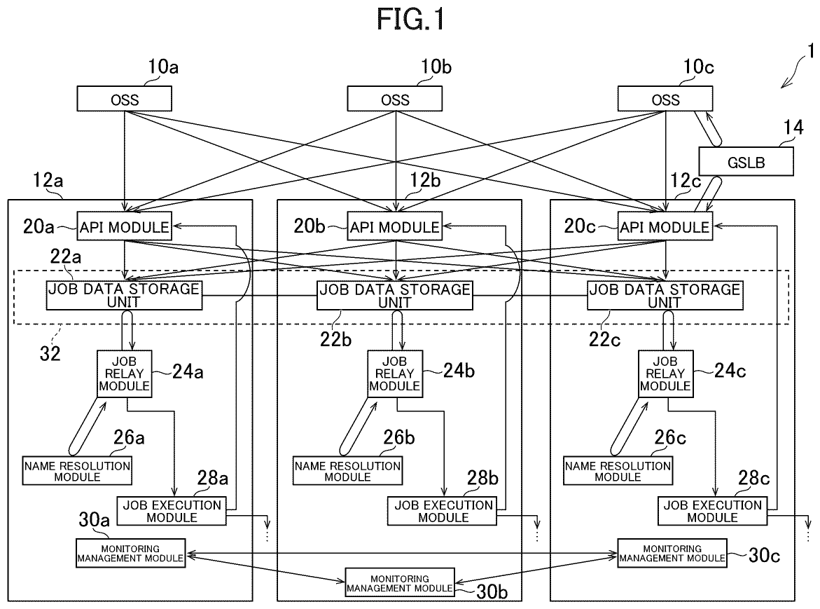

FIG. 1 is a diagram for illustrating an example of a job control system 1 according to the one embodiment of the present invention. As illustrated in FIG. 1, the job control system 1 according to this embodiment includes a plurality of operation support systems (OSSes) 10, a plurality of job execution systems 12, and a global server load balancing (GSLB) 14.

In this embodiment, as an example, in FIG. 1, three OSSes 10 (OSS 10a, OSS 10b, and OSS 10c) are illustrated. Further, in FIG. 1, three job execution systems 12 (job execution system 12a, job execution system 12b, and job execution system 12c) are illustrated. It should be understood that the number of OSSes 10 and the number of job execution systems 12 included in the job control system 1 are not limited to three.

As illustrated in FIG. 1, each job execution system 12 includes an application programming interface (API module) 20, a job data storage unit 22, a job relay module 24, a name resolution module 26, a job execution module 28, and a monitoring management module 30.

In FIG. 1, the API modules 20 included in the job execution system 12a, the job execution system 12b, and the job execution system 12c are indicated as an API module 20a, an API module 20b, and an API module 20c, respectively.

Further, the job data storage units 22 included in the job execution system 12a, the job execution system 12b, and the job execution system 12c are indicated as a job data storage unit 22a, a job data storage unit 22b, and a job data storage unit 22c, respectively.

Further, the job relay modules 24 included in the job execution system 12a, the job execution system 12b, and the job execution system 12c are indicated as a job relay module 24a, a job relay module 24b, and a job relay module 24c, respectively.

Further, the name resolution modules 26 included in the job execution system 12a, the job execution system 12b, and the job execution system 12c are indicated as a name resolution module 26a, a name resolution module 26b, and a name resolution module 26c, respectively.

Further, the job execution modules 28 included in the job execution system 12a, the job execution system 12b, and the job execution system 12c are indicated as a job execution module 28a, a job execution module 28b, and a job execution module 28c, respectively.

Further, the monitoring management modules 30 included in the job execution system 12a, the job execution system 12b, and the job execution system 12c are indicated as a monitoring management module 30a, a monitoring management module 30b, and a monitoring management module 30c, respectively.

Each of the OSSes 10 and the job execution systems 12 in this embodiment is a computer system such as a cloud platform in which a cluster of nodes (which can also be said to be computers or servers) for executing containerized applications is constructed.

Each of the job execution systems 12 in this embodiment may be such as a cluster constructed in a central data center (CDC), which is a data center of a mobile communications carrier.

The clusters in this embodiment are such as sets of nodes in which software (specifically, for example, Kubernetes) for managing containerized workloads and services is installed. Further, the clusters in this embodiment are, for example, each a Kubernetes cluster for which a range of pods being containerized applications can be managed by Kubernetes is defined. A Kubernetes cluster can also be said to be a set of a plurality of nodes on which Kubernetes can deploy a pod.

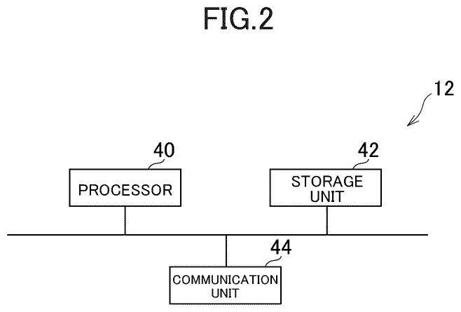

FIG. 2 is a diagram for illustrating an example of a configuration of the job execution system 12 in this embodiment. As illustrated in FIG. 2, each job execution system 12 in this embodiment includes, for example, a processor 40, a storage unit 42, and a communication unit 44. The processor 40 is, for example, a program control device such as a microprocessor which operates in accordance with programs installed in the job execution system 12. The storage unit 42 is, for example, a storage element such as a ROM or a RAM, a solid-state drive (SSD), or a hard disk drive (HDD). The storage unit 42 stores, for example, programs to be executed by the processor 40. The communication unit 44 is, for example, a communication interface such as a network interface card (NIC) or a wireless LAN module. Further, software-defined networking (SDN) may be implemented in the communication unit 44. The communication unit 44 exchanges data with other job execution systems 12, the OSSes 10, the GSLB 14, and clusters constructed in external data centers (for example, regional data centers (RDCs) and edge data centers).

The API module 20 and the monitoring management module 30 illustrated in FIG. 1 are mainly implemented by the processor 40 and the communication unit 44. The job data storage unit 22 is mainly implemented by the storage unit 42. The job relay module 24, the name resolution module 26, and the job execution module 28 are mainly implemented by the processor 40, the storage unit 42, and the communication unit 44.

The above-mentioned functions may be implemented by executing, by the processor 40, a program that is installed in the job execution system 12, which is a computer, and that includes instructions corresponding to the above-mentioned functions. This program may be supplied to the job execution system 12 via a computer-readable information storage medium such as an optical disc, a magnetic disk, a magnetic tape, a magneto-optical disc, a flash memory, or the like, or via the Internet or the like.

The OSS 10 in this embodiment, for example, transmits a job execution request to the job execution system 12. The API module 20 of the job execution system 12 receives the execution request. Examples of the job include a job for constructing a network service (NS). The job execution request may be transmitted to the job execution system 12 in accordance with an instruction by an administrator or a user of the OSS 10.

The OSS 10 may access the GSLB 14 to resolve the name of the transmission destination, and transmit a job execution request to the API module 20 of the job execution system 12 identified as the transmission destination by the name resolution. In FIG. 1, as an example, there is illustrated a case in which the OSS 10c accesses the GSLB 14, but the OSS 10a and the OSS 10b can also access the GSLB 14, although this is not shown in FIG. 1.

The API module 20 generates job data indicating the job to be executed in accordance with the received execution request, and outputs the generated job data to the job data storage unit 22.

The API module 20 may access the GSLB 14 to resolve the name of the output destination, and output the job data to the job data storage unit 22 of the job execution system 12 identified as the output destination by the name resolution. The API module 20 may also output the job data to the job data storage unit 22 of the job execution system 12 including the API module 20. Further, the API module 20 may output the job data to the job data storage unit 22 of a job execution system 12 different from the job execution system 12 including the API module 20. In FIG. 1, as an example, there is illustrated a case in which the job execution system 12c accesses the GSLB 14, but the job execution system 12a and the job execution system 12b can also access the GSLB 14, although this is not shown in FIG. 1.

In this embodiment, for example, the job data storage unit 22 stores the job data indicating the job to be executed. For example, the job data storage unit 22 receives and stores the job data output from the API module 20.

In this embodiment, for example, the job data storage units 22 included in the plurality of job execution systems 12 forms a data grid 32 as a whole. Further, the job data stored in the job data storage unit 22 of any one of the job execution systems 12 is also mirrored to the job data storage units 22 of the other job execution systems 12.

For example, when the job data is stored in the job data storage unit 22a, a copy of this job data is also stored in the job data storage unit 22b and the job data storage unit 22c. Further, when the job data is stored in the job data storage unit 22b, a copy of this job data is also stored in the job data storage unit 22a and the job data storage unit 22c. Further, when the job data is stored in the job data storage unit 22c, a copy of this job data is also stored in the job data storage unit 22a and the job data storage unit 22b.

In this way, in this embodiment, the job data stored in the job data storage unit 22 is synchronized in the plurality of job execution systems 12. Further, each of the plurality of job execution systems 12 in this embodiment are configured to execute at least a part of the job data stored in the job data storage unit 22.

In this embodiment, for example, the job relay module 24 acquires the job data stored in the job data storage unit 22. A condition corresponding to the job relay module 24 is set in the job relay module 24. For example, condition data indicating the condition corresponding to the job relay module 24 is stored in the job relay module 24. Here, the conditions set in the plurality of job relay modules 24 (in the example of FIG. 1, job relay module 24a, job relay module 24b, and job relay module 24c) may be different from each other.

The job relay module 24 acquires the job data satisfying the condition corresponding to the job relay module 24 from the job data storage unit 22. For example, the job relay module 24a acquires the job data satisfying the condition corresponding to the job relay module 24a from the job data storage unit 22. The job relay module 24b acquires the job data satisfying the condition corresponding to the job relay module 24b from the job data storage unit 22. Further, the job relay module 24c acquires the job data satisfying the condition corresponding to the job relay module 24c from the job data storage unit 22.

As illustrated in FIG. 1, the job relay module 24 may acquire the job data from the job data storage unit 22 of the job execution system 12 including the job relay module 24. For example, the job relay module 24a may acquire the job data from the job data storage unit 22a. Further, the job relay module 24b may acquire the job data from the job data storage unit 22b. Further, the job relay module 24c may acquire the job data from the job data storage unit 22c.

In this embodiment, container images of all the job relay modules 24 operating in the job control system 1 are stored in each of all the job execution systems 12. Consequently, it is possible for the job execution system 12a to activate the job relay module 24b having set therein the condition corresponding to the job relay module 24b and to activate the job relay module 24c having set therein the condition corresponding to the job relay module 24c. Further, it is possible for the job execution system 12b to activate the job relay module 24a having set therein the condition corresponding to the job relay module 24a and to activate the job relay module 24c having set therein the condition corresponding to the job relay module 24c. Further, it is possible for the job execution system 12c to activate the job relay module 24a having set therein the condition corresponding to the job relay module 24a and to activate the job relay module 24b having set therein the condition corresponding to the job relay module 24b.

For example, the job data may be linked to location data indicating a location. For example, the job data in this embodiment may be data indicating a job for constructing elements included in a fourth generation (4G) mobile communication system or a fifth generation (5G) mobile communication system. More specifically, for example, the job data may be data indicating a job for constructing elements such as an NS, a network function (NF), a containerized network function component (CNFC), and a pod included in the 4G or 5G communication system. The job data may also include location data indicating a location at which the elements are to be constructed.

The job relay module 24 may be associated with a location. For example, condition data indicating the location associated with the job relay module 24 may be stored in the job relay module 24.

The job relay module 24 may acquire the job data which is linked to the location data indicating the location associated with the job relay module 24, and is stored in the job data storage unit 22. For example, the job relay module 24 may acquire, from the job data storage unit 22, the job data including the location data indicating the location corresponding to the condition data stored in the job relay module 24.

Further, when the job relay module 24 acquires job data from the job data storage unit 22, the job relay module 24 deletes the job data from the job data storage unit 22 of the job execution system 12 in which the job relay module 24 is included. Then, as described above, the job data stored in the job data storage unit 22 is synchronized in the plurality of job execution systems 12, and thus the job data is deleted from the job data storage units 22 of the other job execution systems 12 as well.

In addition, service name data indicating a common service name (for example, a common URL) that is independent of the job execution system 12 is stored in the job relay module 24 in this embodiment. For example, service name data indicating a common URL (for example, “job_1”) is stored in the job relay module 24a, the job relay module 24b, and the job relay module 24c.

In this embodiment, for example, the name resolution module 26 identifies an address (for example, an IP address) unique to the job execution system 12 based on the above-mentioned common service name that is independent of the job execution system 12. Here, the unique address is, for example, the IP address set for the job execution module 28 of the job execution system 12.

The name resolution module 26 may store a DNS record including an A record associating the IP address unique to the job execution system 12 with the common service name that is independent of the job execution system 12.

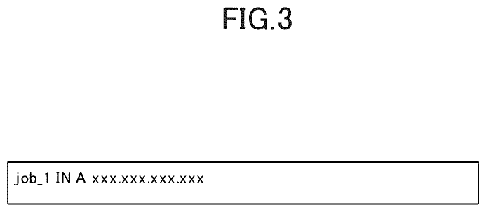

FIG. 3 is a diagram for illustrating an example of a DNS record stored in the name resolution module 26a. As illustrated in FIG. 3, the DNS record stored in the name resolution module 26a may include an A record associating the service name “job_1” with the IP address of the job execution module 28a (in the example of FIG. 3, “xxx.xxx.xxx.xxx”).

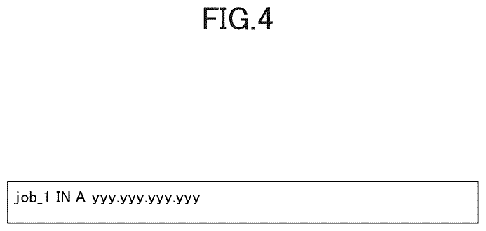

FIG. 4 is a diagram for illustrating an example of a DNS record stored in the name resolution module 26b. As illustrated in FIG. 4, the DNS record stored in the name resolution module 26b may include an A record associating the service name “job_1” with the IP address of the job execution module 28b (in the example of FIG. 4, “yyy.yyy.yyy.yyy”).

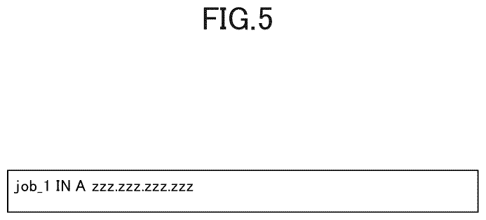

FIG. 5 is a diagram for illustrating an example of a DNS record stored in the name resolution module 26c. As illustrated in FIG. 5, the DNS record stored in the name resolution module 26c may include an A record associating the service name “job_1” with the IP address of the job execution module 28c (in the example of FIG. 5, “zzz.zzz.zzz.zzz”).

The job relay module 24 in this embodiment accesses the name resolution module 26 of the job execution system 12 including the job relay module 24, and executes the name resolution of the service name indicated by the service name data stored in the job relay module 24.

Here, for example, the job relay module 24 transmits the service name data stored in the job relay module 24 to the name resolution module 26. The name resolution module 26 receives the service name data from the job relay module 24, for example. The name resolution module 26 identifies the IP address associated with the service name indicated by the received service name data based on the DNS record stored in the name resolution module 26. The name resolution module 26 then sends the identified IP address back to the job relay module 24.

Here, for example, the job relay module 24a transmits the service name data stored in the job relay module 24a to the name resolution module 26a. The name resolution module 26a receives the service name data transmitted by the job relay module 24a, for example. The name resolution module 26a identifies the IP address of the job execution module 28a being the IP address associated with the service name indicated by the received service name data based on the DNS record stored in the name resolution module 26a. The name resolution module 26a then sends the IP address of the job execution module 28a back to the job relay module 24a.

Similarly, the name resolution module 26b sends the IP address of the job execution module 28b back to the job relay module 24b in response to reception of the service name data from the job relay module 24b. Further, the name resolution module 26c sends the IP address of the job execution module 28c back to the job relay module 24c in response to reception of the service name data from the job relay module 24c.

In this embodiment, for example, the job relay module 24 outputs a job execution request in accordance with the job data acquired from the job data storage unit 22 to the address identified by name resolution based on the above-mentioned common service name by the name resolution module 26 of the job execution system 12 in which the job relay module 24 is included.

In this embodiment, for example, the job execution module 28 receives the job execution request output to the address unique to the job execution system 12 in which the job execution module 28 is included, and executes the job. For example, the job execution module 28a receives, from the job relay module 24a, the job execution request output to the IP address of the job execution module 28a, which is an address unique to the job execution system 12a, and executes the job. Further, the job execution module 28b receives, from the job relay module 24b, the job execution request output to the IP address of the job execution module 28b, which is an address unique to the job execution system 12b, and executes the job. Further, the job execution module 28c receives, from the job relay module 24c, the job execution request output to the IP address of the job execution module 28c, which is an address unique to the job execution system 12c, and executes the job.

In this embodiment, the job execution module 28 may generate at least one new job execution request in response to the reception of the job execution request. For example, in response to the reception of a request to construct an NS, the job execution module 28 may generate a request for the construction of a plurality of NFs included in the NS. Further, in response to the reception of the request to construct the NFs, the job execution module 28 may generate a request for the construction of a plurality of containerized network function components (CNFCs) included in the NFs. In addition, in response to the reception of the request to construct the CNFCs, the job execution module 28 may generate a request for the construction of a plurality of pods included in the CNFCs.

The job execution module 28 may then output at least one newly generated job execution request to the API module 20. Here, the job execution module 28 may output the execution requests to the API module 20 of the job execution system 12 in which the job execution module 28 is included, or may output the execution requests to the API module 20 of another job execution system 12.

Further, for example, in response to the reception of a request to construct a pod, the job execution module 28 may construct the pod. Here, for example, the job execution module 28 may output a pod deployment request to Kubernetes installed in the job execution system 12 or to Kubernetes installed in a cluster of an external data center. The Kubernetes which has received the pod deployment request may deploy the pod.

In this embodiment, for example, the monitoring management module 30 monitors the normality of the path between the job execution systems 12 and whether or not the job execution system 12 is operating normally by performing data communication to/from a monitoring management module 30 operating in another job execution system 12.

In this embodiment, in each of the plurality of monitoring management modules 30, other monitoring management modules 30 to be monitored by that monitoring management module 30 may be set in advance. For example, in the monitoring management module 30a, the monitoring management module 30b and the monitoring management module 30c may be set as the monitoring targets. Further, in the monitoring management module 30b, the monitoring management module 30a and the monitoring management module 30c may be set as the monitoring targets. Further, in the monitoring management module 30c, the monitoring management module 30a and the monitoring management module 30b may be set as the monitoring targets.

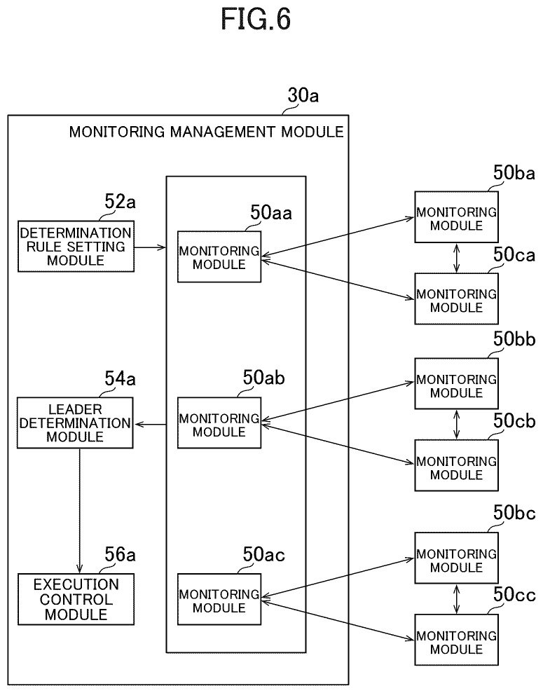

FIG. 6 is a diagram for illustrating an example of a functional configuration of the monitoring management module 30 in this embodiment. In FIG. 6, as an example, the configuration of the monitoring management module 30a included in the job execution system 12a is illustrated.

The monitoring management module 30 includes a plurality of monitoring modules 50 each associated with a job relay module 24. As illustrated in FIG. 6, the monitoring management module 30a includes a monitoring module 50aa, a monitoring module 50ab, and a monitoring module 50ac. The monitoring module 50aa, the monitoring module 50ab, and the monitoring module 50ac are associated with the job relay module 24a, the job relay module 24b, and the job relay module 24c, respectively.

Similarly, the monitoring management module 30b includes a monitoring module 50ba associated with the job relay module 24a, a monitoring module 50bb associated with the job relay module 24b, and a monitoring module 50bc associated with the job relay module 24c. Further, the monitoring management module 30c includes a monitoring module 50ca associated with the job relay module 24a, a monitoring module 50cb associated with the job relay module 24b, and a monitoring module 50cc associated with the job relay module 24c.

Further, the monitoring management module 30 includes a determination rule setting module 52, a leader determination module 54, and an execution control module 56. In FIG. 6, the determination rule setting module 52 is represented as a determination rule setting module 52a, the leader determination module 54 is represented as a leader determination module 54a, and the execution control module 56 is represented as an execution control module 56a.

Similarly, the monitoring management module 30b includes a determination rule setting module 52b, a leader determination module 54b, and an execution control module 56b. Further, the monitoring management module 30c includes a determination rule setting module 52c, a leader determination module 54c, and an execution control module 56c.

The monitoring management module 30 in this embodiment is capable of grasping which job execution system 12 the job relay module 24 is operating in for all job relay modules 24 operating in the job control system 1. For example, for all job relay modules 24 operating in the job control system 1, operation status data indicating the job execution system 12 in which the job relay module 24 is operating is stored in the leader determination module 54. The monitoring management module 30 can identify, for a certain job relay module 24, the job execution system 12 in which the job relay module 24 is operating by referring to the operation status data.

The monitoring modules 50 of the other monitoring management module 30 to be monitored by the monitoring management module 30 may be set in advance in the monitoring modules 50 included in the monitoring management module 30. Further, the monitoring modules 50 included in the monitoring management module 30 may transmit, at predetermined time intervals, elapsed time data indicating the elapsed time since the activation of the monitoring modules 50 to the other monitoring modules 50 set as the monitoring target of the monitoring management module 30.

As illustrated in FIG. 6, the monitoring module 50aa, the monitoring module 50ba, and the monitoring module 50ca transmit and receive elapsed time data to and from each other. Further, the monitoring module 50ab, the monitoring module 50bb, and the monitoring module 50cb transmit and receive elapsed time data to and from each other. Further, the monitoring module 50ac, the monitoring module 50bc, and the monitoring module 50cc transmit and receive elapsed time data to and from each other.

In this embodiment, for example, the determination rule setting module 52 sets, for each of the plurality of job execution systems 12, a determination rule of one or a plurality of alternative execution systems for each job execution system 12. Here, the determination rule setting module 52 may set, for each of the plurality of job execution systems 12, a priority of a job execution system 12 different from the job execution system 12 as the alternative execution system for the job execution system 12. In the following description, a higher priority value indicates a higher priority.

In this embodiment, for example, the determination rule setting module 52 receives, under a state in which none of the monitoring modules 50 have been activated, priority data indicating a priority value from a terminal used by the administrator of the job control system 1. The determination rule setting module 52 then sets the above-mentioned determination rule based on the priority data.

For example, it is assumed that the determination rule setting module 52a receives priority data indicating a priority as an alternative execution system for the job execution system 12a. For example, it is assumed that the determination rule setting module 52a receives priority data indicating “10” as the priority value of the job execution system 12b and “1” as the priority value of the job execution system 12c.

In this case, the determination rule setting module 52a determines the timing for activating the monitoring module 50ba and the monitoring module 50ca based on the value of the received priority data. At this time, in this embodiment, for example, the activation timing is determined so that a higher priority indicates an earlier timing for activating the corresponding monitoring module 50. In this example, the job execution system 12b has a higher priority than the job execution system 12c. Consequently, the timing for activating the monitoring module 50ba and the timing for activating the monitoring module 50ca are determined so that the timing for activating the monitoring module 50ba is earlier than the timing for activating the monitoring module 50ca.

The determination rule setting module 52a transmits activation timing data indicating the timing for activating the monitoring module 50ba to the determination rule setting module 52b, and the determination rule setting module 52b activates the monitoring module 50ba at the activation timing indicated by the activation timing data.

Further, the determination rule setting module 52a transmits activation timing data indicating the timing for activating the monitoring module 50ca to the determination rule setting module 52c, and the determination rule setting module 52c activates the monitoring module 50ca at the activation timing indicated by the activation timing data.

In this case, the monitoring module 50ba is activated at a time earlier than a time to activate the monitoring module 50ca.

In this embodiment, the activation timing of the monitoring module 50aa, which is a monitoring module 50 included in the job execution system 12a and is associated with the job relay module 24a included in the job execution system 12a, is determined so that the activation timing of the monitoring module 50aa is earlier than the activation timings of the monitoring module 50ba and the monitoring module 50ca. The determination rule setting module 52a activates the monitoring module 50aa at a time earlier than times to activate the monitoring module 50baand the monitoring module 50ca.

Further, for example, it is assumed that the determination rule setting module 52b receives priority data indicating a priority as an alternative execution system for the job execution system 12b. For example, it is assumed that the determination rule setting module 52b receives priority data indicating “10” as the priority value of the job execution system 12c and indicating “1” as the priority value of the job execution system 12a. In this case, the same process as the process described above is executed, and the monitoring module 50cb is activated at a time earlier than a time to activate the monitoring module 50ab.

Further, in this embodiment, the activation timing of the monitoring module 50bb, which is a monitoring module 50 included in the job execution system 12b and is associated with the job relay module 24b included in the job execution system 12b, is determined so that the activation timing of the monitoring module 50bb is earlier than the activation timings of the monitoring module 50ab and the monitoring module 50cb. The determination rule setting module 52b activates the monitoring module 50bb at a time earlier than times to activate the monitoring module 50ab and the monitoring module 50cb.

Further, it is assumed that the determination rule setting module 52c receives priority data indicating a priority as an alternative execution system for the job execution system 12c. For example, it is assumed that the determination rule setting module 52c receives priority data indicating “10” as the priority value of the job execution system 12a and “1” as the priority value of the job execution system 12b. In this case, the same process as the process described above is executed, and the monitoring module 50ac is activated at a time earlier than a time to activate the monitoring module 50bc.

In this embodiment, the activation timing of the monitoring module 50cc, which is a monitoring module 50 included in the job execution system 12c and is associated with the job relay module 24c included in the job execution system 12c, is determined so that the activation timing of the monitoring module 50cc is earlier than the activation timings of the monitoring module 50ac and the monitoring module 50bc. The determination rule setting module 52c activates the monitoring module 50cc at a time earlier than times to activate the monitoring module 50ac and the monitoring module 50bc.

In this embodiment, for example, the monitoring modules 50 monitor each element included in the job execution system 12 in which those monitoring modules 50 are operating. The monitoring modules 50 stop the monitoring management module 30 including those monitoring module 50 in response to occurrence of a predetermined event, for example, a system failure or an element hang-up in the job execution system 12. The monitoring modules 50 may also stop the job relay module 24 being executed in the job execution system 12 in response to the occurrence of a predetermined event, for example, a system failure or an element hang-up in the job execution system 12.

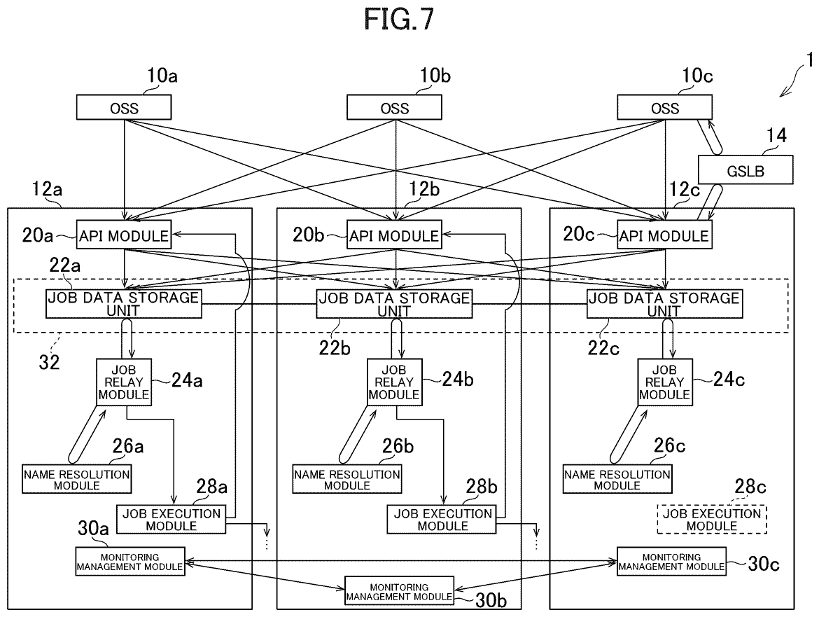

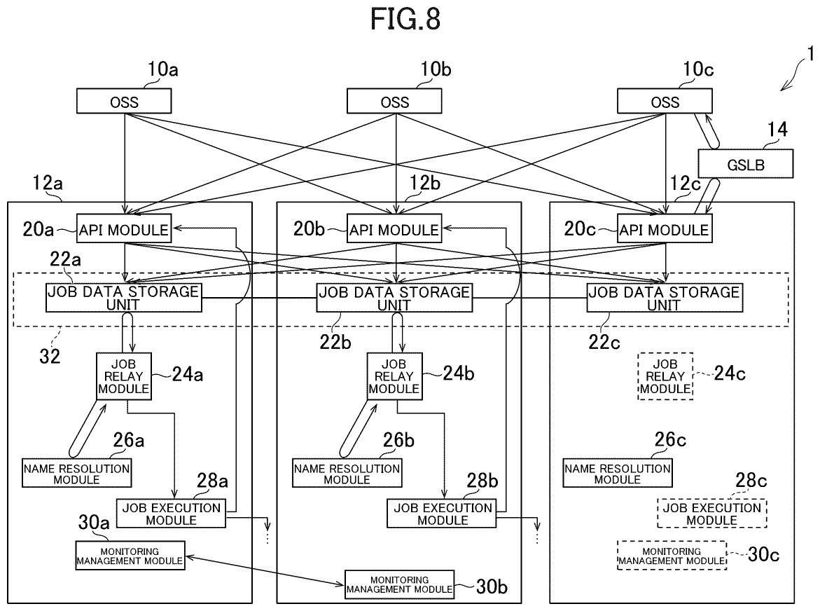

For example, when an abnormality such as a hang-up occurs in the job execution module 28c as illustrated in FIG. 7, the monitoring management module 30c stops the job relay module 24c and then stops itself, as illustrated in FIG. 8.

In this embodiment, for example, in a case in which a network disconnection occurs, and a monitoring management module 30 becomes unable to communicate to/from more than half of the other monitoring management modules 30 set as the monitoring targets of that monitoring management module 30, in such a case, the monitoring management module 30 may stop the job relay module 24c of the job execution system 12 included in the monitoring management module 30, and then stop itself. For example, when the monitoring management module 30c becomes unable to communicate to/from the monitoring management module 30a and the monitoring management module 30b, the monitoring management module 30c may stop the job relay module 24c, and then stop itself.

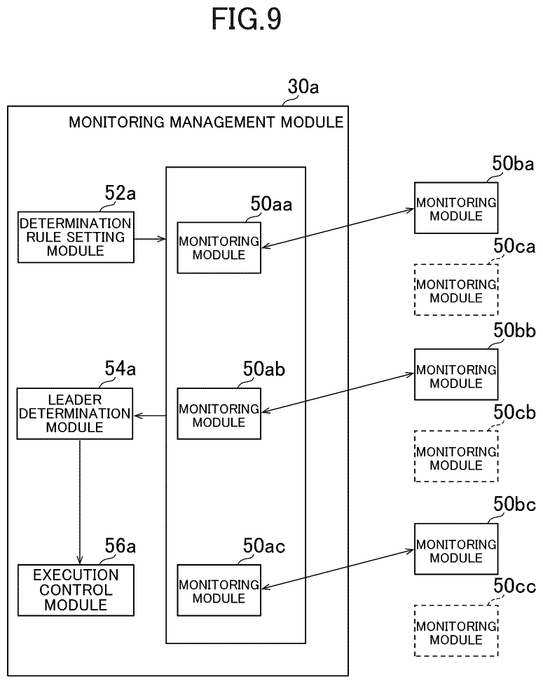

In this way, when the monitoring management module 30c stops, as illustrated in FIG. 9, the monitoring module 50aa and the monitoring module 50ba detect a communication disconnection to/from the monitoring module 50ca. Further, the monitoring module 50ab and the monitoring module 50bb detect a communication disconnection to/from the monitoring module 50cb. Moreover, the monitoring module 50ac and the monitoring module 50bc detect a communication disconnection to/from the monitoring module 50cc. As a result, the monitoring management module 30a and the monitoring management module 30b determine, in accordance with a rule determined in advance, an alternative system being the job execution system 12 to execute the job relay module 24c which has been executed in the job execution system 12c instead.

Here, for example, the leader determination module 54a identifies that the job relay module 24 operating in the job execution system 12c, which includes the monitoring module 50ca, the monitoring module 50cb, and the monitoring module 50cc in which a communication disconnection has been detected, is the job relay module 24c. Further, the leader determination module 54a may identify the elapsed time since the activation of the monitoring modules 50 associated with the job relay module 24c. For example, the leader determination module 54a may identify the elapsed time indicated by the latest elapsed time data received by the monitoring module 50ac from the monitoring module 50bc, and the elapsed time since the activation of the monitoring module 50ac at the timing when the elapsed time data is received. When the elapsed time since the activation of the monitoring module 50ac is longer than the elapsed time indicated by the latest elapsed time data received by the monitoring module 50ac from the monitoring module 50bc, the leader determination module 54a may determine that the job execution system 12a is the alternative system for the job execution system 12c. Conversely, when the elapsed time indicated by the latest elapsed data received by the monitoring module 50ac from the monitoring module 50bc is longer than the elapsed time since the activation of the monitoring module 50ac, the leader determination module 54a may determine that the job execution system 12a is not the alternative system for the job execution system 12c.

In the same manner, the leader determination module 54b may determine whether or not the job execution system 12b is the alternative system for the job execution system 12c.

As described above, when the monitoring module 50ac is activated at a time earlier than a time to activate the monitoring module 50bc, the leader determination module 54a determines that the job execution system 12a is the alternative system for the job execution system 12c. Further, the leader determination module 54b determines that the job execution system 12b is not the alternative system for the job execution system 12c.

In this embodiment, for example, the execution control module 56 executes control so that, in response to the occurrence of a predetermined event in any one of job execution systems 12, the job relay module 24 executed by that job execution system 12 is executed in the alternative system for the job execution system 12. Here, the execution control module 56 may execute control so that, when a predetermined event occurs in any one of the job execution systems 12, the job relay module 24 stopped by a monitoring module 50 of that job execution system 12 in response to the occurrence of the predetermined event is executed in the alternative system for that job execution system 12.

Further, in this embodiment, for example, the execution control module 56 executes control so that, in response to the occurrence of a predetermined event in a job execution system 12, the job relay module 24 executed by that job execution system 12 is executed by one or a plurality of other job execution systems 12 which are alternative execution systems determined in accordance with the determination rule set for that job execution system 12. Here, the execution control module 56 may execute control so that the job relay module 24 is executed in one or a plurality of job execution systems 12 which are alternative execution systems determined in accordance with the priority set for that job execution system 12.

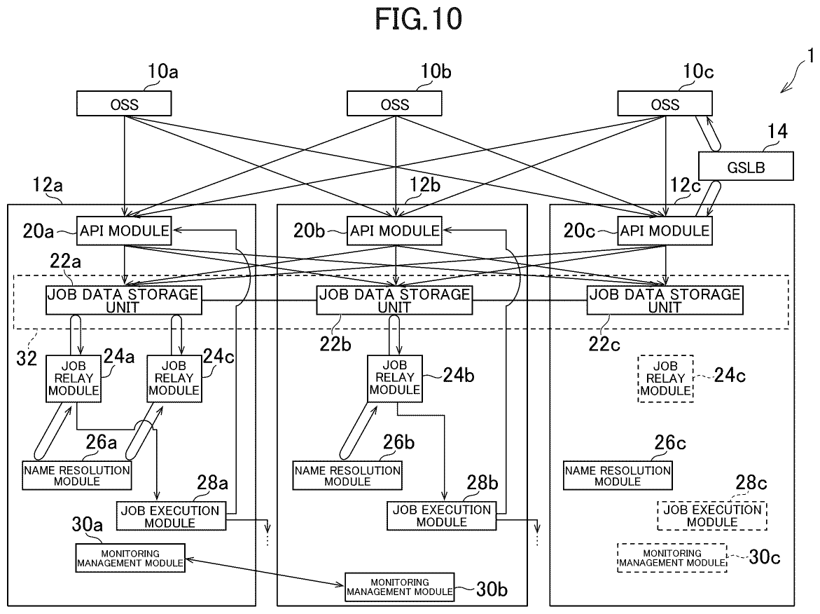

In the examples described above, the execution control module 56 included in the alternative system for the job execution system 12c activates the job relay module 24c. This job relay module 24c stores the same condition data and service name data described above as those used when operating in the job execution system 12c. For example, as described above, when the job execution system 12a is determined as the alternative system, in this case, as illustrated in FIG. 10, the job relay module 24c starts operation in the job execution system 12a.

The job relay module 24c which has started operation in the job execution system 12a acquires job data satisfying the same condition as that satisfied when operating in the job execution system 12c from the job data storage unit 22a.

In this way, when the job relay module 24c starts operation in the job execution system 12a, the job to be executed in the job execution system 12c in which the predetermined event has occurred is instead executed in the job execution system 12a.

In this case, in the job execution system 12a, the acquisition from the job data storage unit 22a of the job data satisfying the condition corresponding to the job relay module 24a, and the execution of the job indicated by the acquired job data by the job execution module 28a continue.

In this way, in this embodiment, the job to be executed in the job execution system 12c is executed instead by the job execution system 12a without affecting the operation of the job relay module 24a. At this time, it is sufficient that the job relay module 24c be activated by the job execution system 12a, and it is not required to make a complicated change to the settings.

In this way, according to this embodiment, it is possible to smoothly execute the job to be executed in a certain job execution system 12 in another job execution system 12 instead.

Further, when the job execution system 12 to execute the job in place of the job execution system 12 in which the event such as a system failure has occurred is randomly determined, there is a fear in that the load on the job execution systems 12 may become uneven.

As described above, in this embodiment, an alternative execution system for the job execution system 12 can be set by the determination rule setting module 52 based on, for example, an operation of the administrator. In this way, in this embodiment, it is possible to control the alternative execution system for the job execution system 12, and thus, according to this embodiment, the load sharing among the plurality of job execution systems 12 can be appropriately optimized.

The job execution system 12 in this embodiment transmits, when execution of a job by the job execution module 28 finishes, a job completion notification to the OSS 10 which requested the execution of the job. Here, when a predetermined time has elapsed since the OSS 10 transmitted the job execution request to the job execution system 12 and a timeout occurs, the job execution request is re-transmitted to the job execution system 12. For example, in a case in which the job execution module 28c hangs and a timeout occurs when the job execution module 28c is executing a job in the job execution system 12c, even in such a situation, according to this embodiment, the OSS 10 re-transmits the job execution request to the job execution system 12, and the job is executed by the job execution module 28c which has started to be operated in the job execution system 12a.

The job data storage unit 22 may also be implemented, for example, by Apache Kafka (trademark). Further, the job relay module 24 may be implemented, for example, as Kafka Consumer.

Moreover, the name resolution module 26 may be implemented by a coreDNS being a DNS server which provides name resolution services.

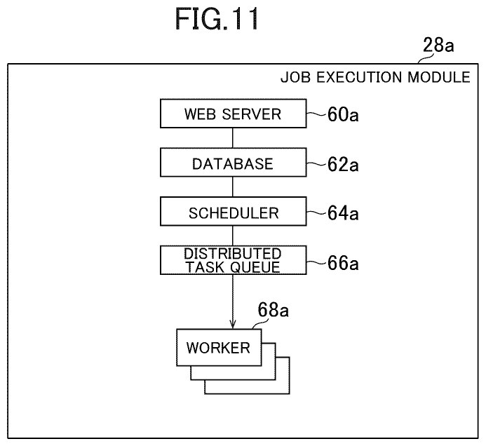

The job execution modules 28 may be implemented by a workflow engine such as Apache Airflow (trademark). As illustrated in FIG. 11, each execution job module 28 may include a web server 60, a database 62, a scheduler 64, a distributed task queue 66 such as Celery and a plurality of workers 68. The jobs may be executed in a distributed manner by the plurality of workers 68. The web server 60, the database 62, the scheduler 64, the distributed task queue 66, and the workers 68 may be implemented as pods. In FIG. 11, there are illustrated, as an example, a web server 60a, a database 62a, a scheduler 64a, a distributed task queue 66a, and workers 68a included in the job execution module 28a illustrated in FIG. 1.

Further, for example, the web server 60 may receive a job execution request from the job relay module 24 and store the received job execution request in the database 62. The scheduler 64 may enqueue the tasks of the workflow in accordance with this execution request to the distributed task queue 66. The workers 68 may dequeue the tasks from the distributed task queue 66 and execute the tasks.

Further, in this embodiment, the workers 68 may be linked to the job relay module 24. The worker 68a may be labeled with a label of the job relay module 24a. The distributed task queue 58a may set the label of the job relay module 24a to the tasks corresponding to the job execution request received from the job relay module 24a. The workers 68a may then execute the tasks labeled with the label of the job relay module 24a.

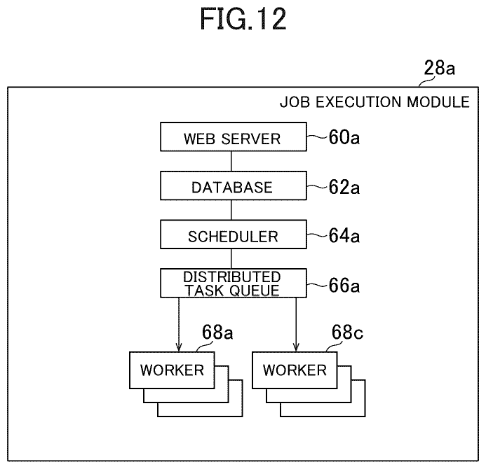

When the job execution system 12a is determined to be the alternative system in the manner described above, and the monitoring management module 30a activates the job relay module 24c, as illustrated in FIG. 12, a plurality of workers 68c may be activated. At this time, for example, the number of workers 68c which have been executed in the job execution system 12c may be additionally activated. In this case, the operations of the workers 68c are started in the job execution system 12a. The workers 68c may then execute the tasks labeled with a label of the job relay module 24c.

The monitoring module 50 may be implemented to include, for example, an etcd. Then, the etcd may transmit elapsed time data indicating the elapsed time since the activation of the etcd at predetermined time intervals to another etcd set as a monitoring target of the etcd.

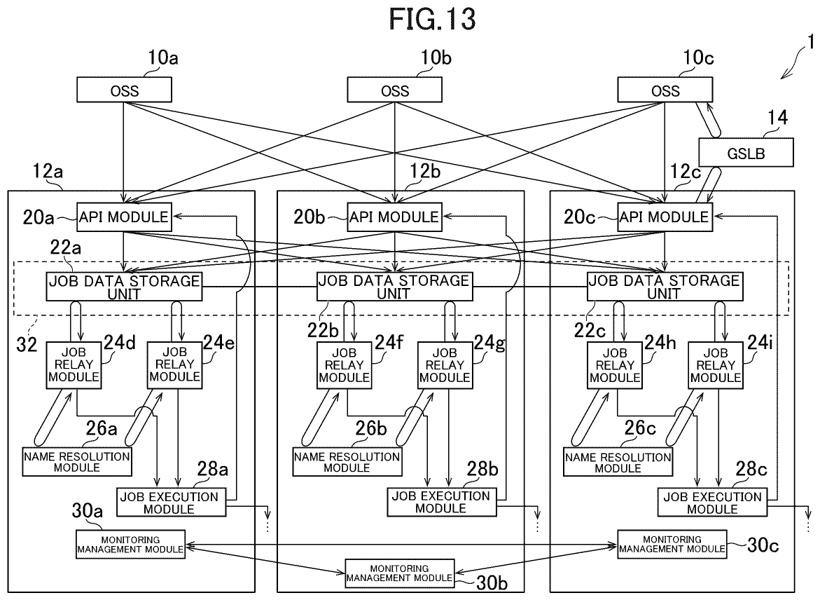

Further, in this embodiment, as illustrated in FIG. 13, a plurality of job relay modules 24 may be executed in each job execution system 12. In the example of FIG. 13, a job relay module 24d and a job relay module 24e are executed in the job execution system 12a. In addition, a job relay module 24f and a job relay module 24g are executed in the job execution system 12b. Moreover, a job relay module 24h and a job relay module 24i are executed in the job execution system 12c. The job relay module 24d, the job relay module 24e, the job relay module 24f, the job relay module 24g, the job relay module 24h, and the job relay module 24i store condition data indicating a condition different from one another.

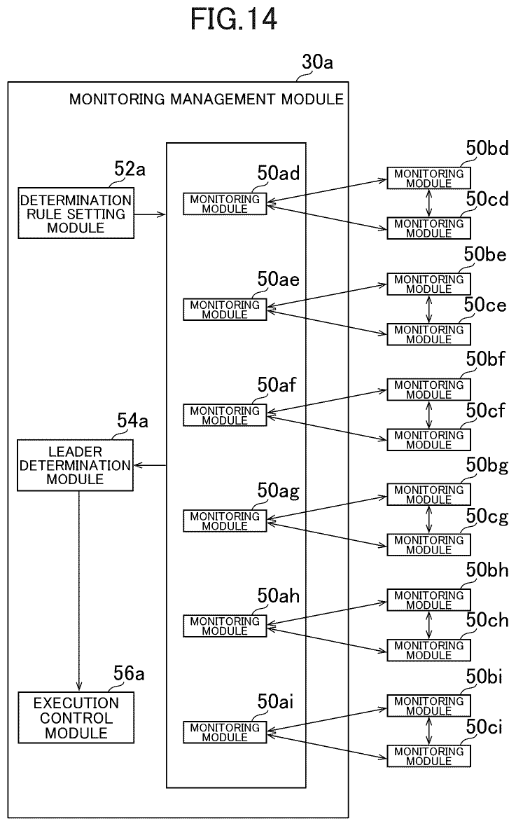

In this case, as illustrated in FIG. 14, the monitoring management module 30a includes a monitoring module 50ad, a monitoring module 50ae, a monitoring module 50af, a monitoring module 50ag, a monitoring module 50ah, and a monitoring module 50ai. The monitoring module 50ad, the monitoring module 50ae, the monitoring module 50af, the monitoring module 50ag, the monitoring module 50ah, and the monitoring module 50ai are associated with the job relay module 24d, the job relay module 24e, the job relay module 24f, the job relay module 24g, the job relay module 24h, and the job relay module 24i, respectively. Similarly, the monitoring management module 30b includes a monitoring module 50bd associated with the job relay module 24d, a monitoring module 50be associated with the job relay module 24e, a monitoring module 50bf associated with the job relay module 24f, a monitoring module 50bg associated with the job relay module 24g, a monitoring module 50bh associated with the job relay module 24h, and a monitoring module 50bi associated with the job relay module 24i. Further, the monitoring management module 30c includes a monitoring module 50cd associated with the job relay module 24d, a monitoring module 50ce associated with the job relay module 24e, a monitoring module 50cf the job relay module 24f, a monitoring module 50cg associated with the job relay module 24g, a monitoring module 50ch associated with the job relay module 24h, and a monitoring module 50ci associated with the job relay module 24i.

In this example, the determination rule setting module 52 sets, for each of the plurality of job execution systems 12, another plurality of job execution systems 12 as alternative execution systems for each job execution system 12.

For example, the determination rule setting module 52a sets the job execution system 12b and the job execution system 12c as the alternative execution systems for the job execution system 12a. Further, the determination rule setting module 52b sets the job execution system 12a and the job execution system 12c as the alternative execution systems for the job execution system 12b. Further, the determination rule setting module 52c sets the job execution system 12a and the job execution system 12b as the alternative execution systems for the job execution system 12c.

For example, the determination rule setting module 52a may execute control so that the monitoring module 50bd is activated at a time earlier than a time to activate the monitoring module 50cd. Further, the determination rule setting module 52a may execute control so that the monitoring module 50ad is activated at a time earlier than times to activate the monitoring module 50bd and the monitoring module 50cd.

Further, the determination rule setting module 52a may execute control so that the monitoring module 50ce is activated at a time earlier than a time to activate the monitoring module 50be. Further, the determination rule setting module 52a may execute control so that the monitoring module 50ae is activated at a time earlier than times to activate the monitoring module 50be and the monitoring module 50ce.

Further, the determination rule setting module 52b may execute control so that the monitoring module 50af is activated at a time earlier than a time to activate the monitoring module 50cf. Further, the determination rule setting module 52b may execute control so that the monitoring module 50bf is activated at a time earlier than times to activate the monitoring module 50af and the monitoring module 50cf.

Further, the determination rule setting module 52b may execute control so that the monitoring module 50cg is activated at a time earlier than a time to activate the monitoring module 50ag. Further, the determination rule setting module 52b may execute control so that the monitoring module 50bg is activated at a time earlier than times to activate the monitoring module 50ag and the monitoring module 50cg.

Further, the determination rule setting module 52c may execute control so that the monitoring module 50ah is activated at a time earlier than a time to activate the monitoring module 50bh. Further, the determination rule setting module 52c may execute control so that the monitoring module 50ch is activated at a time earlier than times to activate the monitoring module 50ah and the monitoring module 50bh.

Further, the determination rule setting module 52c may execute control so that the monitoring module 50bi is activated at a time earlier than a time to activate the monitoring module 50ai. Further, the determination rule setting module 52c may execute control so that the monitoring module 50ci is activated at a time earlier than times to activate the monitoring module 50ai and the monitoring module 50bi.

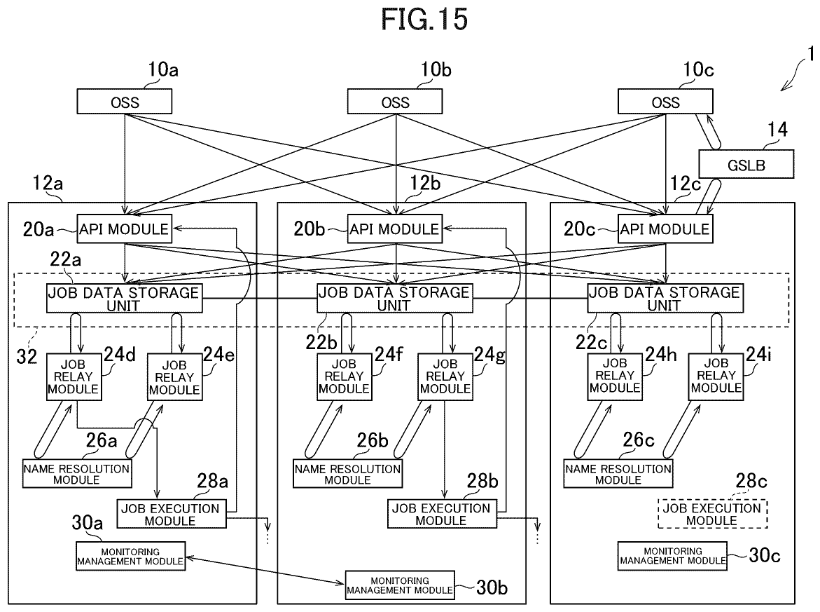

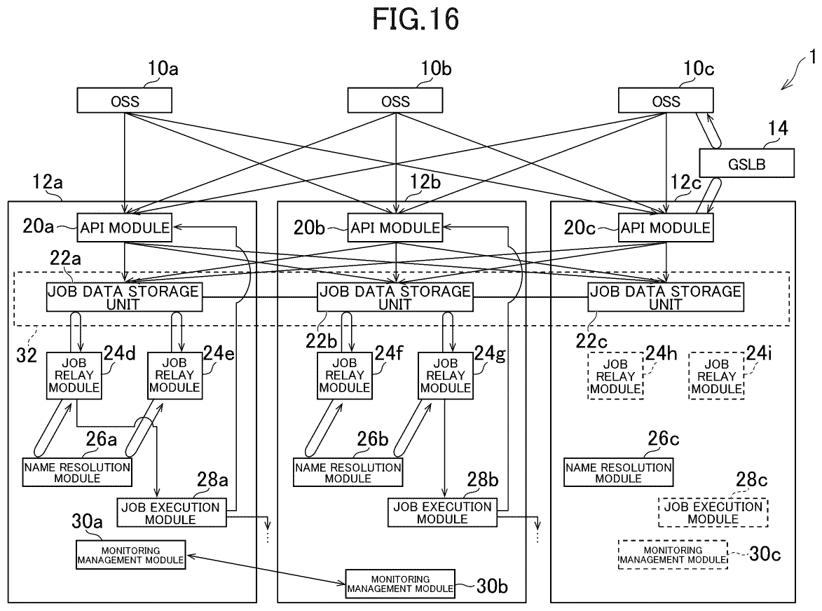

In a case in which a predetermined event, for example, a hang-up of the job execution module 28c has occurred in the job execution system 12c as illustrated in FIG. 15, in this case, as illustrated in FIG. 16, the monitoring management module 30c stops the job relay module 24h and the job relay module 24i operating in the job execution system 12c, and then stops itself.

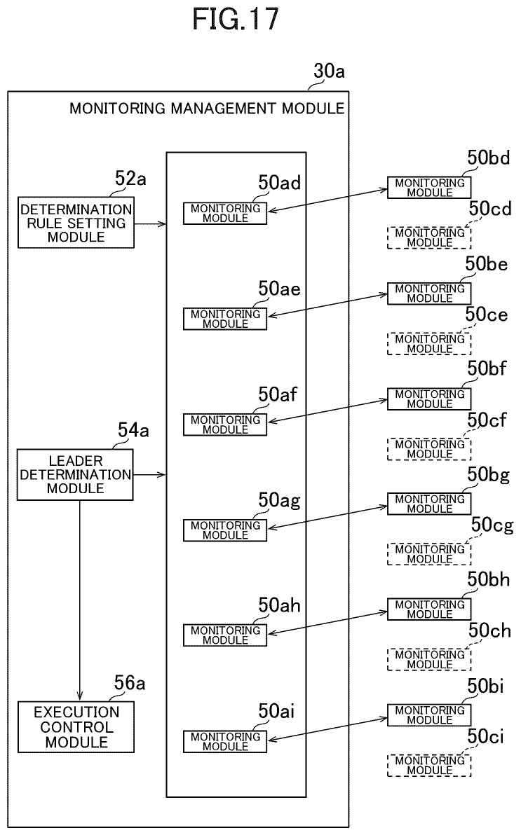

In this way, when the monitoring management module 30c stops, as illustrated in FIG. 17, the monitoring module 50ad and the monitoring module 50bd detect a communication disconnection to/from the monitoring module 50cd. Further, the monitoring module 50ae and the monitoring module 50be detect a communication disconnection to/from the monitoring module 50ce. Moreover, the monitoring module 50af and the monitoring module 50bf detect a communication disconnection to/from the monitoring module 50cf. Further, the monitoring module 50ag and the monitoring module 50bg detect a communication disconnection to/from the monitoring module 50cg. Further, the monitoring module 50ah and the monitoring module 50bh detect a communication disconnection to/from the monitoring module 50ch. Moreover, the monitoring module 50ai and the monitoring module 50bi detect a communication disconnection to/from the monitoring module 50ci. As a result, the monitoring management module 30a and the monitoring management module 30b determine, in accordance with a rule determined in advance, an alternative system for each of the job relay module 24h and the job relay module 24i which have been executed in the job execution system 12c.

Here, for example, the monitoring management module 30a and the monitoring management module 30b may each determine to execute one mutually different job relay module 24 in the job execution system 12a and the job execution system 12b. For example, the monitoring management module 30a may determine the job execution system 12a to be the alternative system for the job relay module 24h. Then, the monitoring management module 30b may determine the job execution system 12b to be the alternative system for the job relay module 24i.

As described above, when the monitoring module 50ah is activated at a time earlier than the time to activate the monitoring module 50bh, the monitoring management module 30a determines the job execution system 12a to be the alternative system for the job relay module 24h. Further, as described above, when the monitoring module 50bi is activated at a time earlier than the time to activate the monitoring module 50ai, the monitoring management module 30b determines the job execution system 12b to be the alternative system for the job relay module 24i.

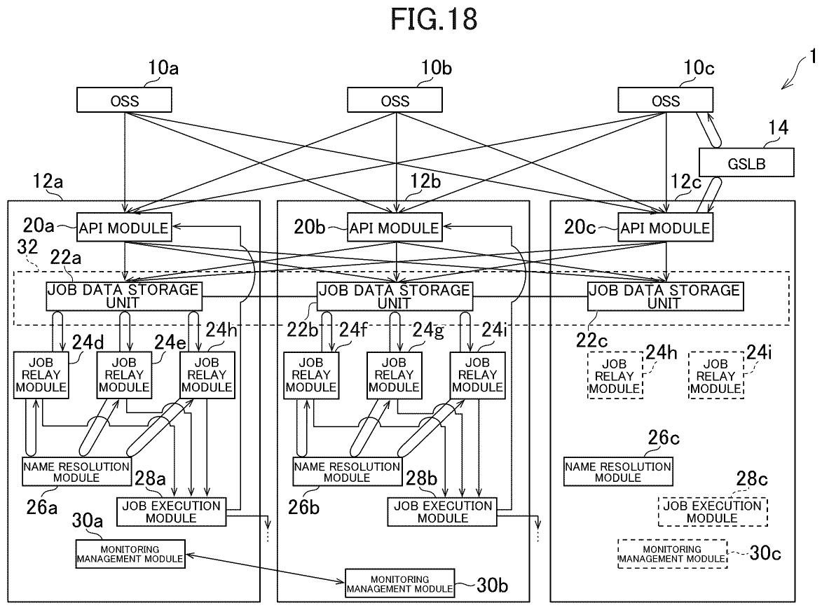

The execution control module 56a may activate the job relay module 24h which has been executed in the job execution system 12c. Further, the execution control module 56b may activate the job relay module 24i which has been executed in the job execution system 12c. In this case, as illustrated in FIG. 18, the job relay module 24h may start operation in the job execution system 12a, and the job relay module 24i may start operation in the job execution system 12b.

In this way, the execution control module 56 may execute control so that, in response to the occurrence of a predetermined event in a job execution system 12 in which a plurality of job relay modules 24 are executed, the plurality of job relay modules 24 are executed in a distributed manner in a plurality of other job execution systems 12.

When a single job execution system 12 executes the job in place of the job execution system 12 in which an event such as a system failure has occurred, the load on the job execution system 12 suddenly increases. In the job control system 1 illustrated in FIG. 13, as described above, in response to the occurrence of a predetermined event in the job execution system 12 in which a plurality of job relay modules 24 are executed, the plurality of job relay modules 24 are executed in a distributed manner in a plurality of other job execution systems 12. Accordingly, according to the job control system 1 illustrated in FIG. 13, a sudden increase in the load on the job execution system 12 can be suppressed.

Further, even in the job control system 1 illustrated in FIG. 13, it is possible to smoothly execute the job to be executed in a certain job execution system 12 in another job execution system 12 instead.

Further, even in the job control system 1 illustrated in FIG. 13, an alternative execution system for the job execution system 12 can be set by the determination rule setting module 52 based on, for example, an operation of the user. Thus, even in the job control system 1 illustrated in FIG. 13, it is possible to control the alternative execution system for the job execution system 12. Accordingly, even in the job control system 1 illustrated in FIG. 13, the load sharing among the plurality of job execution systems 12 can be appropriately optimized.

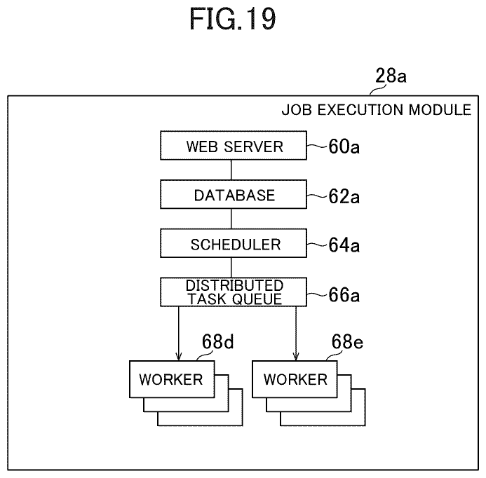

FIG. 19 is a diagram for illustrating an example of the job execution module 28a illustrated in FIG. 13. As illustrated in FIG. 19, the execution job module 28a includes the web server 60a, the database 62a, the scheduler 64a, the distributed task queue 66a, workers 68d, and workers 68e. The workers 68d may execute the tasks labeled with a label of the job relay module 24d. The workers 68e may execute the tasks labeled with a label of the job relay module 24e.

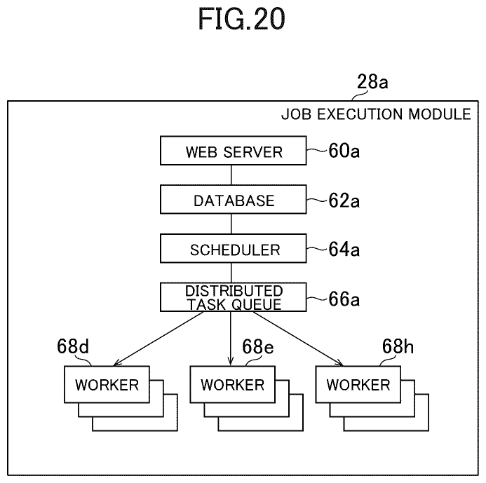

When the monitoring management module 30a activates the job relay module 24h, as illustrated in FIG. 20, a plurality of workers 68h may be activated. The workers 68h may then execute the tasks labeled with a label of the job relay module 24h.

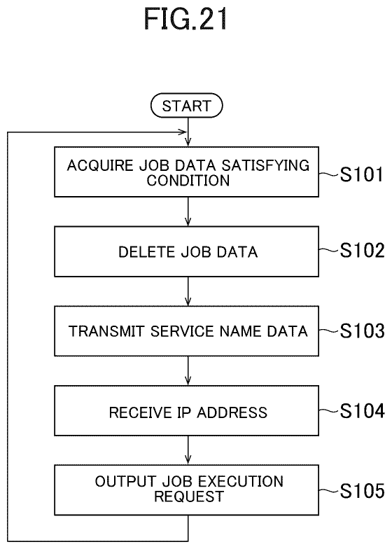

Description is now given of an example of a flow of a process executed by the job relay module 24a of the job execution system 12a in this embodiment with reference to a flow chart illustrated in FIG. 21.

First, the job relay module 24a acquires job data satisfying the condition indicated by the condition data stored in the relay job module 24a from the job data storage unit 22a (Step S101).

Then, the job relay module 24a deletes the job data acquired in the process step of Step S101 from the job data storage unit 22a (Step S102).

The job relay module 24a then transmits the service name data stored in the job relay module 24a to the name resolution module 26a (Step S103).

Then, the job relay module 24a receives an IP address, which is a reply to the service name data transmitted in the process step of Step S103, from the name resolution module 26a (Step S104).

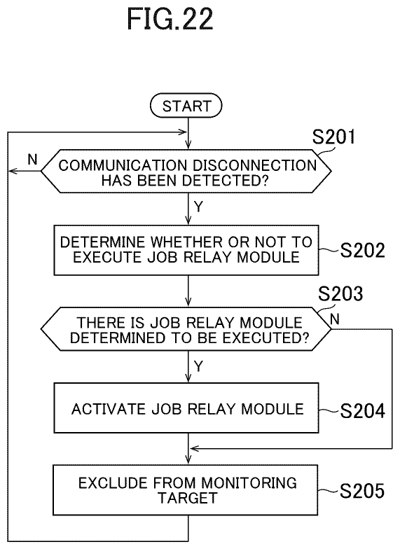

Then, the job relay module 24a outputs a job execution request in accordance with the job data acquired in the process step of Step S101 to the IP address received in the process step of Step S104 (Step S105), and the process returns to Step S101. Description is now given of an example of a flow of process executed by the monitoring management module 30a in this embodiment with reference to a flow chart illustrated in FIG. 22.

The monitoring management module 30a monitors the normality of communication to/from the monitoring management module 30b and the monitoring management module 30c by transmitting data to/from each of the monitoring management modules 30 to be monitored (Step S201). In the process step of Step S201, for example, each of the monitoring modules 50 included in the monitoring management module 30a monitors the normality of communication to/from the other monitoring modules 50 set as monitoring targets of that monitoring module 50.

In a case in which a monitoring module 50 of the monitoring management module 30a detects a communication disconnection between the monitoring module 50 and any one of the monitoring modules 50, in this case, the leader determination module 54a of the monitoring management module 30a determines, for each of the one or the plurality of job relay modules 24 which have been executed in the job execution system 12 including the monitoring module 50 in which the communication disconnection has been detected, in accordance with the determination rule described above, whether or not to execute that job relay module 24 in the job execution system 12a (Step S202).

The execution control module 56a then examines whether or not there is at least one job relay module 24 determined to be executed in the job execution system 12a (Step S203).

When there is at least one job relay module 24 determined to be executed in the job execution system 12a (Step S203: Y), in this case, the execution control module 56a of the monitoring management module 30a activates the job relay module 24 determined to be executed in the job execution system 12a, which has been executed in the job execution system 12 including the monitoring management module 30 in which a communication disconnection has been detected (Step S204). In the process step of Step S204, the execution control module 56a may activate the worker 68 corresponding to the activated job relay module 24 as well.

When there is no job relay module 24 determined to be executed in the job execution system 12a (Step S203: N), or when the process step of Step S204 has ended, the monitoring modules 50 of the monitoring management module 30a excludes the monitoring modules 50 in which a communication disconnection has been detected from the monitoring targets (Step S205). Then, the process returns to Step S201.

Note that, the present invention is not limited to the embodiment described above.

For example, the determination rule setting module 52 is not required to set an alternative execution system by controlling the activation order or activation timing of the monitoring modules 50. For example, the determination rule setting module 52 may store alternative execution system data indicating the alternative execution system.

The leader determination module 54 may determine whether or not the job execution system 12 in which the leader determination module 54 is included is the alternative system based on the alternative execution system data.

For example, the determination rule setting module 52a may store alternative execution system data indicating the job execution system 12c. Further, the determination rule setting module 52b may store alternative execution system data indicating the job execution system 12a. Further, the determination rule setting module 52c may store alternative execution system data indicating the job execution system 12b.

In this case, when a communication disconnection to/from the job execution system 12c is detected, the leader determination module 54a may determine that the job execution system 12a is the alternative system for the job execution system 12c. The leader determination module 54b may determine that the job execution system 12b is not the alternative system for the job execution system 12c. Further, the execution control module 56a may activate the job relay module 24 which has been executed in the job execution system 12c.

As another example, the determination rule setting module 52a may store priority data including a value “1” corresponding to the job execution system 12b and a value “10” corresponding to the job execution system 12c. Further, the determination rule setting module 52b may store priority data including a value “1” corresponding to the job execution system 12c and a value “10” corresponding to the job execution system 12a. Further, the determination rule setting module 52c may store priority data including a value “1” corresponding to the job execution system 12a and a value “10” corresponding to the job execution system 12b.

In this case, when a communication disconnection to/from the job execution system 12c is detected, the leader determination module 54a and the leader determination module 54b may identify the value corresponding to the job execution system 12c in the priority data stored in each determination rule setting module 52. For example, a value “10” corresponding to the job execution system 12c for the priority data stored in the determination rule setting module 52a and a value “1” corresponding to the job execution system 12c for the priority data stored in the determination rule setting module 52b may be identified.

The leader determination module 54a may determine whether or not the job execution system 12a is the alternative system based on a comparison result of the identified values. Further, the leader determination module 54b may determine whether or not the job execution system 12b is the alternative system based on a comparison result of the identified values.

In the example described above, the value “10” identified for the determination rule setting module 52a is greater than the value “1” identified for the determination rule setting module 52b. In this case, the leader determination module 54a may determine that the job execution system 12a is the alternative system for the job execution system 12c. The leader determination module 54b may determine that the job execution system 12b is not the alternative system for the job execution system 12c. Further, the execution control module 56a may activate the job relay module 24 which has been executed in the job execution system 12c.

For example, the above-mentioned predetermined event is not limited to a hang-up of the job execution module 28, and may be, for example, a node failure of a cluster failure of the entire job execution system 12.

1. A job control system, comprising:
job data storage storing job data indicating a job to be executed; and
a plurality of job execution systems each configured to execute at least a part of the job data stored in the job data storage,
each of the plurality of job execution systems including:
at least one processor; and
at least one memory device storing instruction which, when executed by the at least one processor; cause the at least one processor to perform operations comprising:
executing at least one job relay each associated with a condition;
identifying an address unique to the each of the plurality of job execution systems based on a common service name that is independent of the each of the plurality of job execution systems; and
receiving a job execution request output to the unique address and executing the job,
wherein the job relay is configured to acquire the job data which is stored in the job data storage, and satisfies the condition associated with the job relay, and
wherein the job relay is configured to output a job execution request in accordance with the acquired job data to the address identified by name resolution based on the common service name by one of the plurality of job execution systems in which the job relay is included.

2. The job control system according to claim 1, which the operations further comprise executing control so that, in response to occurrence of a predetermined event in any one of the plurality of job execution systems, the job relay executed in the one of the plurality of job execution systems is executed in another job execution system.

3. The job control system according to claim 1, which the operations further comprises:
stopping, in response to occurrence of a predetermined event in any one of the plurality of job execution systems, the at least one job relay executed in the one of the plurality of job execution systems; and
executing control so that the at least one job relay is executed in another job execution system.

4. The job control system according to claim 1,
wherein the job data is linked to location data indicating a location,
wherein the job relay is associated with the location, and
wherein the job relay is configured to acquire the job data which is stored in the job data storage, and is linked to the location data indicating the location associated with the job relay. 5. A control method for a job control system,
the job control system including:
job data storage for storing job data indicating a job to be executed; and
a plurality of job execution systems each configured to execute at least a part of the job data stored in the job data storage,
each of the plurality of job execution systems including:
at least one; and
at least one memory device storing instructions which, when executed by the at least one processor, cause the at least one processor to perform operations comprising:
executing at least one job relay each associated with a condition;
identifying an address unique to the each of the plurality of job execution systems based on a common service name that is independent of the each of the plurality of job execution systems; and
receiving a job execution request output to the unique address and executing the job,
the control method comprising:
acquiring, by the job relay, the job data which is stored in the job data storage, and satisfies the condition associated with the job relay; and
outputting, by the job relay, a job execution request in accordance with the acquired job data to the address identified by name resolution based on the common service name by one of the plurality of job execution systems in which the job relay is included.
